(19) United States
(12) Patent Application Publication
(10) Pub. No.: US 2010/0214635 A1
(43) Pub. Date: Aug. 26, 2010

(54) DISPLAY DEVICE, DISPLAY METHOD AND HEAD-UP DISPLAY

(75) Inventors: Takashi Sasaki, Kanagawa-ken (JP); Aira Hotta, Tokyo (JP); Haruhiko Okumura, Kanagawa-ken (JP); Naotada Okada, Kanagawa-ken (JP); Kazuo Horiuchi, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/728,876

(22) Filed: Mar. 22, 2010

Related U.S. Application Data
(63) Continuation of application No. PCT/JP2008/002720, filed on Sep. 29, 2008.

(30) Foreign Application Priority Data
Nov. 22, 2007 (JP) 2007-302584

(51) Int. Cl. G02B 26/08; G02B 27/10; G02B 5/04; G02B 5/32

(52) U.S. Cl. 359/15; 359/619; 359/831; 359/298

(57) ABSTRACT

A display device, generating light flux containing image information and making the light flux incident to one-eye of an image viewer by controlling an angle of divergence of the light flux is provided. The device includes a first lens, a second lens and an angle of divergence control device provided between the first lens and the second lens, the angle of divergence control device being configured to control the angle of divergence of the light flux.

### CROSS-REFERENCE TO RELATED APPLICATIONS

This is a continuation application of International Application PCT/JP2008/002720, filed on Sep. 29, 2008. This application also claims priority to Japanese Application No. 2007-302584, filed on Nov. 22, 2007. The entire contents of each are incorporated herein by reference.

### TECHNICAL FIELD

This invention relates to a display device, a display method and a head-up display.

### BACKGROUND ART

A high quality display device reproducing visual realities for human visual sense has been developed. A sense of depth is extremely important as one of visual realities and technology development for perception of the sense of depth is a critical issue.

Conventionally, the sense of depth for the human visual sense has been considered to be most effected by a binocular parallax. That is, it is said that different images between both eyes are generated by convergence at gazing an object of view by a human and the binocular parallax allows the perception of the sense of depth.

Proposed methods based on the effect of this binocular parallax are illustratively an anaglyph method using red and blue filters, a method using polarized filter glasses, a method using a liquid crystal shutter, a method visually identifying interlace images for right-and-left eyes via a lenticular plate and a method presenting an independent projected image to right-and-left eyes via a head mounted display HMD (Head Mounted Display) mounted on an identifier's head or the like. Various methods based on these binocular parallax effects suffer from an enormous work necessary for image processing to produce a plurality of projected images for right-and-left eyes and complexity of display devices.

On the other hand, a projected image may be presented to a one-eye (single eye) in the HMD, however, the perception is limited to a small projected image presented by a display unit placed extremely near to the eye and a high sense of realism can not be presented with the sense of depth.

Moreover, there is a head-up display HUD (Head-Up Display) allowing projected driving information such as a vehicle speed or the like on a windscreen to be viewed and simultaneous visual identification of external information and vehicle information. A technique adding the sense of depth to the HUD is strongly desired for safer drive of vehicles. It is noted that a technique presenting a display image to only one-eye in the HUD is disclosed (Patent Citation 1), however, the technique has no effect enhancing the perception of depth, because it is aimed at preventing double images in visual identification with both eyes.

Furthermore, a technique relating to certification of human in order to specify location of the identifier's head is disclosed in Patent Citation 2.

### Patent Citation 1: Patent 7-228172 (JP-A H07-228172 (Kokai))

### Patent Citation 2: Patent 3279913 (Japanese Patent No. 3279913)

### DISCLOSURE OF INVENTION

### Technical Problem

The object the present invention is to provide a display device, a display method and a head-up display which allows the perceivable projected image of the enhanced sense of depth to be achieved easily and a high sense of realism to be displayed without necessity of a complex device configuration and image processing and supports the safer driving of vehicles or the like.

### Technical Solution

According to an aspect of the invention, there is provided a display device, generating light flux containing image information and making the light flux incident to one-eye of an image viewer by controlling an angle of divergence of the light flux, the device including a first lens, a second lens and an angle of divergence control device provided between the first lens and the second lens, the angle of divergence control device being configured to control the angle of divergence of the light flux.

According to another aspect of the invention, there is provided a display device including: a light flux generation unit configured to generate light flux containing image information; a field of view control unit configured to make the light flux incident to a one-eye of an image viewer; and an image formation unit configured to form an image based on the light flux, the image formation unit including an optical element nearest to the one-eye of constituent optical elements, which is placed apart from the one-eye by 21.7 cm or more, at least one of the field of view control unit and the image formation unit including a first lens, a second lens and an angle of divergence control device provided between the first lens and the second lens, the angle of divergence control device being configured to control the angle of divergence of the light flux.

According to another aspect of the invention, there is provided a display method, generating light flux containing image information and making the light flux incident to a one-eye of an image viewer by controlling an angle of divergence of the light flux by using a first lens, a second lens and an angle of divergence control device provided between the first lens and the second lens, the angle of divergence control device being configured to control the angle of divergence of the light flux.

According to another aspect of the invention, there is provided a display method, generating light flux containing image information, and making the light flux incident to a one-eye by placing an optical element nearest to the one-eye of an image viewer apart from the one-eye by 21.7 cm or more by using a first lens, a second lens and an angle of divergence control device provided between the first lens and the second lens, the angle of divergence control device being configured to control the angle of divergence of the light flux.

According to another aspect of the invention, there is provided a head-up display including: a light flux projection unit configured to output light flux containing image information configured to be incident to one-eye of an driver; an angle of divergence control mechanism configured to control an angle of divergence of the light flux, the angle of divergence control mechanism including a first lens, a second lens and an angle of divergence control device provided between the first lens and the second lens, the angle of divergence control device being configured to control the angle of divergence of the light flux; and a transparent plate provided with a reflective layer having the light flux projected thereon with the angle of divergence controlled by the angle of divergence control mechanism.

### BRIEF DESCRIPTION OF DRAWINGS

FIGS. 1A to 1C are schematic views illustrating the configuration of a display device according to a first embodiment of the invention.

FIG. 2 is a graph illustrating the experimental result on characteristics of the display device according to the first embodiment of the invention.

FIGS. 3A and 3B are schematic views illustrating the experimental optical system for evaluating the characteristics of the display device according to the first embodiment of the invention.

FIG. 4 is a graph illustrating the experimental result on the characteristics evaluation of the display device according to the first embodiment of the invention.

FIG. 5 is a schematic cross-sectional side view illustrating the configuration of a display device according to a second embodiment of the invention.

FIGS. 6A to 6H are schematic views illustrating the shape of light flux of the display device according to the second embodiment of the invention.

FIGS. 7A to 7E are schematic views illustrating the angle of divergence control unit of the display device according to the second embodiment of the invention.

FIGS. 8A to 8D are schematic views illustrating the angle of divergence control unit of the display device according to the second embodiment of the invention.

FIGS. 9A to 9T are schematic views illustrating the image formation unit of the display device according to the second embodiment of the invention.

FIG. 10 is a schematic view illustrating the configuration of a display device according to a third embodiment of the invention.

FIG. 11 is a schematic view illustrating the configuration of a display device according to a fourth embodiment of the invention.

FIG. 12 is a schematic view illustrating the configuration of a display device according to a fifth embodiment of the invention.

FIG. 13 is a schematic view illustrating the configuration of a display device according to a sixth embodiment of the invention.

FIG. 14 is a schematic view illustrating the configuration of a display device according to a seventh embodiment of the invention.

FIG. 15 is a schematic view illustrating the configuration of a display device according to an eighth embodiment of the invention.

FIG. 16 is a schematic view illustrating the configuration of a display device according to a ninth embodiment of the invention.

FIG. 17 is a schematic view illustrating the configuration of a display device according to a tenth embodiment of the invention.

FIG. 18 is a schematic view illustrating the configuration of a display device according to an eleventh embodiment of the invention.

FIG. 19 is a schematic view illustrating the configuration of a display device according to a twelfth embodiment of the invention.

FIG. 20 is a flow chart illustrating a display method according to a thirteenth embodiment of the invention.

FIG. 21 is a flow chart illustrating a display method according to a fourteenth embodiment of the invention.

FIG. 22 is a flow chart illustrating a display method according to a fifteenth embodiment of the invention.

FIG. 23 is a flow chart illustrating a display method according to a sixteenth embodiment of the invention.

FIG. 24 is a schematic view showing applications of the display device, the display method and the head-up display according to the embodiments of the invention.

### EXPLANATION OF REFERENCE

10, 20, 23, 24, 25, 26, 27, 28, 29, 30, 31, 40 display device
70 head-up display (HUD)
100 image viewer
101, 105 one-eye
110 light flux generation unit
111 projector
112 light flux
112a irradiation area
130 image formation unit
131 screen
150 field of view control unit
151 liquid crystal shutter glasses
152 pair of polarizing glasses
160 image formation unit
162a, 162b flat plate mirror
163a, 163b concave mirror
164a, 164b prism
165a diffusion screen
166b light transmission plate
167 highly reflective layer
168 laminated optical body
170, 370 divergence control unit
171 lens
172, 401 lenticular plate
172a semi-cylindrical lens
173 holographic diffuser
173a micro irregularity
174 micro lens
175 grated index type micro lens
190 optical element
230 half mirror
250 image projector
251, 252 polarizing filter
260 screen
262 background projected image
270 specified reference mark
271 depth direction
371, 372 lens
373 aperture
374 light source
375 collimator unit
378 projection lens
402, 402a aspheric Fresnel lens
403 view for viewing
461, 463 image
462, 762 virtual image
601 control unit
602 image pickup unit
603 image judgment unit
604 image signal unit
700 driver
710 front glass (window shield, transparent plate)
711 reflective layer (half mirror)
720 dashboard
730 car (vehicle)
740 divergence control mechanism
750 light flux projection unit

### BEST MODE FOR CARRYING OUT THE INVENTION

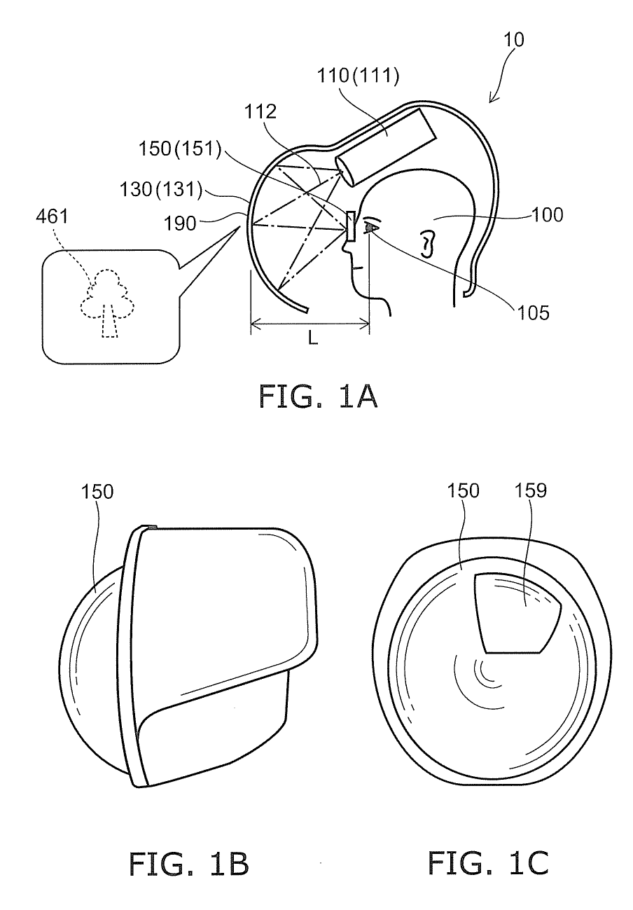

FIG. 1 shows schematic views illustrating the configuration of a display device according to a first embodiment of the invention.

FIGS. 1A, 1B, 1C are a schematic side view of cross section, a schematic side view, and a schematic front view, respectively.
As shown in FIG. 1A, a display device 10 of the first embodiment is a kind of a head mount type display device (HMD), and has a light flux generation unit 110 generating light flux 112 containing image information, an image formation unit 130 forming an image based on the light flux 112 and a field of view control unit 150 controlling the light flux 112 to make the light flux 112 incident to one-eye 105 of an image viewer 100.

The light flux generation unit 110 can be illustratively a projector 111 and generates the light flux 112 forming a projected image. In FIG. 1, it is illustratively provided over a head of an image viewer 100. The image formation unit 130 is, for example, a screen 131 shaped like a dome, is provided in front of the image viewer 100, reflects the light flux 112 to form an image 461. Moreover, the field of view control unit 150 is illustratively a liquid crystal shutter glasses 151 in FIG. 1, making the light flux 112 incident to the one-eye of the image viewer 100. In addition, the liquid crystal shutter glasses 151 can be configured to make the light flux 112 incident to an eye of ascendant eye side of the image viewer 100 and not to make the light flux 112 incident to an eye of non-ascendant eye side.

In the display device 10 illustrated in FIG. 1, a distance between the image formation unit 130 and the eye of the image viewer 100 (one-eye 105 for viewing) is set to 27 cm. That is, an optical element 190 comprising the image formation unit 130 is the screen 131, the optical element 190 nearest to the one-eye 105 of the image viewer 100 is the screen 131 and the distance between the optical element 190 nearest to the one-eye 105 of the image viewer 100 and the one-eye 105 for viewing is set to 27 cm.

As described above, a displayed image with an enhanced sense of depth can be provided by presenting the projected image to the one-eye 105 for viewing using the display device 10. This allows the perceivable projected image of the enhanced sense of depth to be achieved easily and a high sense of realism to be displayed without necessity of a complex device configuration and image processing.

Hereinafter, details will be described.

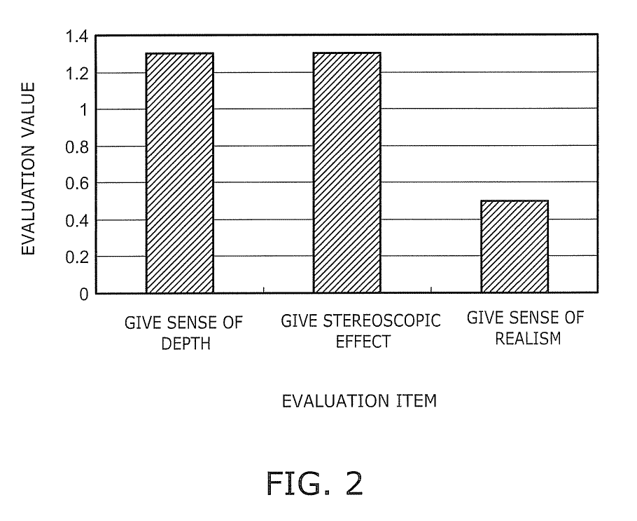

FIG. 2 is a graph illustrating the experimental result on characteristics of the display device according to the first embodiment of the invention.

FIG. 2 shows the result on subjective evaluation of a sense of depth when viewed with a one-eye (single eye) and when viewed with both eyes. That is, in the display device 10 illustrated in FIG. 1, the liquid crystal shutter glasses 151 are used, thus this shutter operation allows alternate view by switching between a state of the one-eye and a state of both eyes. Moreover, various projected test images are displayed and the subjective evaluation was performed about display performance when the images were viewed by monocular vision in comparison with the performance when viewed by binocular vision. Here, three kinds of evaluation items, “give a sense of depth”, “give a stereoscopic effect” and “give a sense of realism” were evaluated using an evaluation scale of seven ranks in total composed of values of −3, −2, −1, 0, 1, 2 and 3. Furthermore, an evaluation value in the state of monocular vision was determined by assuming subjective evaluation of view by the binocular vision as 0 (standard). Positive values are obtained in all three evaluation items, indicating superiority of the monocular vision over the binocular vision (standard). The horizontal axis in FIG. 2 represents three kinds of evaluation items and the vertical axis represents the respective evaluation value on the evaluation item. It is noted that, in the above evaluation items, “give a sense of depth” is mainly related to the evaluation on perception of a depth relationship among a plurality of objects appearing in a viewed projected image, “give a stereoscopic effect” is mainly related to the evaluation on perception of a stereoscopic effect of a shape of one object appearing in the projected image, and “give a sense of realism” is mainly related to realistic perceptibility of an image space in considering all of them.

As shown in FIG. 2, any of evaluation items indicates positive values. It has been found that the view by the monocular vision allows display of “give a sense of depth”, “give a stereoscopic effect” and “give a sense of realism” to be achieved compared with the binocular vision.

The perception of enhanced sense of depth achieved by the above monocular vision has an absolutely different principle from conventional perception of the sense of depth by the binocular vision. Hereafter, experiments performed about the enhanced effect of perceiving the sense of depth by the monocular vision will be described.

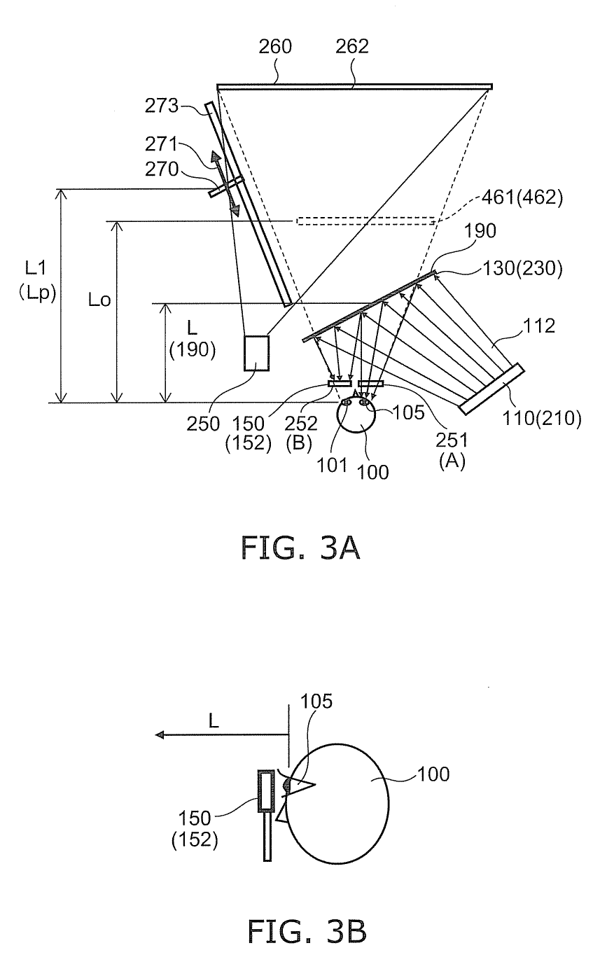

FIG. 3 shows schematic views illustrating the experimental optical system for evaluating characteristics of the display device according to the first embodiment of the invention.

FIG. 3A is a schematic plan view of the experimental optical system, and FIG. 3B is a schematic view showing the state of the image viewer in the experiment. As shown in FIG. 3A, a liquid crystal display (LCD) 210 is used as the light flux generation unit 110 generating the light flux 112. A half mirror 230 made of acryl is used as the image formation unit 130. Moreover, a pair of polarizing glasses 152 having polarizing filters with a different polarized direction in left and right eyes is used as the field of view control unit 150. The light flux 112 outgoing from the LCD 210 is reflected on the half mirror 230 made of acryl, and the image viewer 100 views the image 461 (virtual image 462) obtained by this reflection. Here, the pair of polarizing glasses 152 is adjusted so that a polarizing filter 251 (A) is in a light transmission state and another polarizing filter 252 (B) is in a light blocking state to the image reflected on the half mirror 230. This enables the image viewer 100 to view the image with only one-eye 105 for viewing and not to view the image with another one-eye 101. Moreover, a background projected image 262 is projected on a screen 260 using an image projector 250.

Furthermore, a distance of depth perceived on the projected image from the LCD 210 is measured varying a distance L from the half mirror 230 to the one-eye 105 of the image viewer 100 for viewing. It is noted that a distance between the LCD 210 and the half mirror 230 is 30 cm. The distance L from the half mirror 230 to the one-eye 105 for viewing is varied in a range of 10 cm to 100 cm. Here, a standard point of the distance to the half mirror 230 is set to a center point in a reflection area of the half mirror 230 reflecting the light flux 112.

Furthermore, a rail 273 is provided along a depth direction 271 on a side of the field of view for viewing of the image viewer 100, a specified reference mark 270 is placed on the rail 273 so that the reference mark 270 can be moved along the depth direction 271. And when the image viewer 100 views the image 461 (virtual image 462), the reference mark 270 is placed at the position giving the same sense of depth as the sense of depth perceived with regard to its image 461 (virtual image 462) and a distance L1 from an eyepoint of the image viewer 100 thereat to the reference mark 270 is measured. The distance L1 is taken as a perceived depth distance Lp. In addition, as shown in FIG. 3B, the image viewer 100 side plane of a frame section of the pair of polarizing glasses 152 is substantially taken as a position of a forehead of the image viewer 100, and the distance L1 between the reference mark 270 and the eyepoint of the image viewer 100 is measured from the one-eye 105.

In addition, in the experimental optical system shown in FIG. 3A, the light flux generation unit 110 based on the LCD 210, the image formation unit 130 based on the half mirror 230 and the field of view control unit 150 based on the pair of polarizing glasses 152 having the light flux incident to the one eye can constitute the display device of the first embodiment of the invention. And the optical element 190 comprising the image formation unit 130 is the half mirror 230. In other words, among the optical elements 190 comprising the image formation unit 130, the optical element 190 nearest to the one-eye 105 of the image viewer 100 for viewing is the half mirror 230.

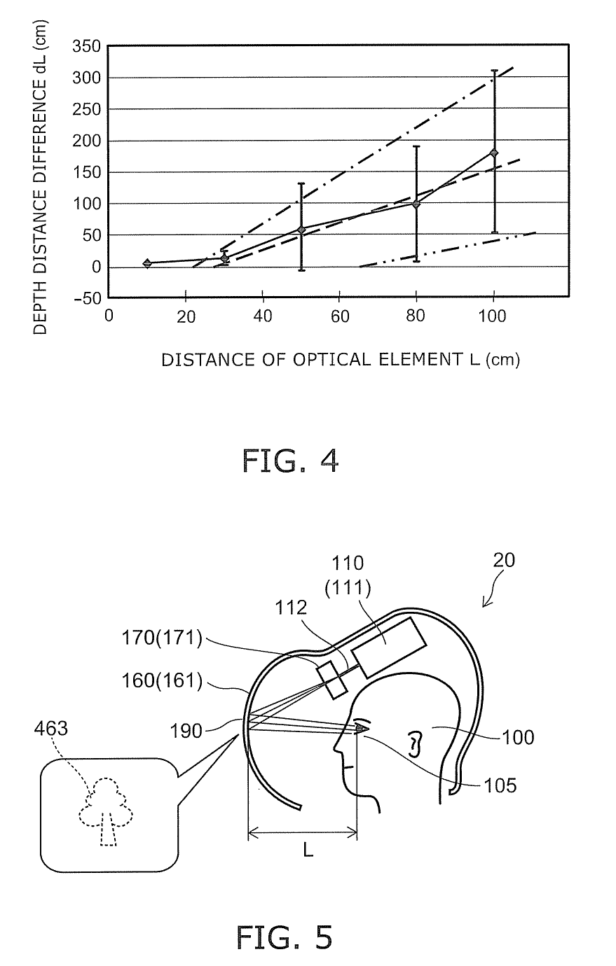

FIG. 4 is a graph illustrating the experimental result on the characteristics evaluation of the display device according to the first embodiment of the invention.

The horizontal axis of FIG. 4 represents the distance L (distance of optical element) from the half mirror 230 to the one-eye 105 of the image viewer 100 for viewing. The vertical axis of FIG. 4 represents a difference (depth distance difference) L between a distance Lo from the formation position of the virtual image 462 to the one-eye 105 of the image viewer 100 and the perceived depth distance Lp. That is, when the perceived depth coincide with the position of the virtual image, dL is 0. Positive values of dL indicate that the perceived depth distance Lp is larger than the distance Lo of the position of the virtual image. More specifically, the depth distance difference dL indicates an enhancement degree of the sense of depth.
A solid line in FIG. 4 represents experimental data, and error bars indicating an average of dL and a standard deviation in the case where the distance of the optical element is L are displayed. Furthermore, based on the experimental data of L of 30 cm or more, approximate straight lines are determined about a center value and an upper and lower limit of the standard deviation, then the approximate straight line of the average value is displayed by a broken line, the approximate straight line of the upper limit of the standard deviation is displayed by a dashed line and the approximate straight line of the lower limit of the standard deviation is displayed by a chain double-dashed line.

As shown by the solid line of FIG. 4, when the distance L of the optical element is small, the depth distance difference dL is close to 0, and the perceived sense of the depth is nearly the same as the depth to the virtual image. However, if L is over about 20 cm, dL increases, and it is shown that the viewed image is perceived to be located deeper than the virtual image 461.

In other words, it has been found that the sense of depth is enhanced at the distance L of the optical element forming the image longer than about 20 cm in viewing of the image by the one-eye.

Hereafter, details will be described.

As a result of continuing investigation about a projection system of a one-eye, the inventor has found that a big factor of characteristics of the display system is the position of the optical element 190 nearest to the image viewer 100, namely, the nearest optical element. That is, the position of the optical element 190 placed in front of eyes is an important big factor of depth perception of humans sensing projected images presented by the display device.

The display plane of the image projection system serves as the most forehand anchor point among positions of perceptible sense of depth. It has been found that placement of this anchor point farther by the specified value or more and presentation of the projected image to the one-eye enable the projected image to be perceived farther within an adjustment margin of the human sense of depth.

This invention has been made on the basis of the new finding about the human monocular vision illustrated in FIG. 4.

For example, in a conventional single eye method MHD, a display unit (image formation unit) is placed just in front of the eye of the image viewer, and a distance between the image formation unit and the eye is a few cm or less. Thus, the image formation unit placed nearer than the human adjustment limit cannot be the anchor point. Therefore, since the human views the projected image assuming the image is placed at easily perceptible position, the human only perceives that a small display plane (display) is located just in front of the eye, being impossible to perceive the sense of depth.

In contrast to this, in the display device of the embodiment of the invention, as the optical element 190 (nearest optical element) nearest to the one-eye 105 for viewing presents the image to the one-eye 105 with being farther than the specified position (placed farther), the sense of depth can be enhanced.

It is considered that a human sense of sight judges a depth distance more clearly by using a finite difference between a physical object to be perceived and an existing assigned position. In the optical system illustrated in FIG. 3, the plane of the optical element 190 (half mirror 230 illustratively in FIG. 3) nearest to the image viewer considered to be used as the nearest assigned position (nearest optical element) in judgment of the sense of depth. When the nearest assigned position is very close, the perceived sense of depth is placed near, because the position of the virtual image 462 is trailed to the nearest assigned position. Therefore, the difference between the distance Lo to the virtual image 462 and the perceived sense of depth Lp is small. However, if the nearest assigned point (half mirror 230) is placed farther by the specified value or more, the subjective virtual image depth position is considered to be placed farther to be more easily perceived due to an error of perception.

Furthermore, FIG. 4 is described.

As shown by the dashed line in FIG. 4, it has been found that the approximate characteristics of the upper limit of the standard deviation of the experimental data is dL=3.7614×L−81.619(R2=0.9624), and the perceived depth distance begins to go deeper than the position of the virtual image at L of 21.7 cm or more.

Moreover, as shown by the broken line in FIG. 4, the approximate characteristics of the center value is dL=2.2221×L−56.634 (R2=0.9495), and the perceived depth distance is deeper than the position of the virtual image at L of 25.5 cm or more.

Furthermore, as shown by the chain double-dashed line in FIG. 4, it has been found that the approximate characteristics of the lower limit of the standard deviation is dL=1.2029×L−76.237(R2=0.8871), and almost all image viewers perceive the sense of depth deeper than the virtual image formation position.

Therefore, in the display device 10 of the first embodiment of the invention, placement is made so that the distance between the optical element 190 (nearest optical element) nearest to the one-eye 105 of the image viewer 100 among the constituent optical elements 190 and the one-eye 105 is preferably 21.7 cm or more, furthermore preferably 25.5 cm or more and still furthermore preferably 63.4 cm or more.

In addition, like the display device 10 illustrated in FIG. 1, a semi-transparent area 159 may be provided on a part of the screen 131 to enable an outside background image and the image 461 (virtual image 462) to be viewed simultaneously.

### Second Embodiment

Next, a second embodiment will be described.

FIG. 5 is a schematic cross-sectional side view illustrating the configuration of a display device according to a second embodiment of the invention.

As shown in FIG. 5, a display device 20 of the second embodiment of the invention is a kind of HMD and includes the light flux generation unit 110 generating the light flux 112 containing image information, an image formation unit 160 forming the image on the basis of the light flux 112 and an angle of divergence control unit 170 making the light flux 112 incident to the one-eye of the image viewer by controlling the angle of divergence. It is noted that “control” includes not only active control but also passive control making the flux diverge to have the specified angle of divergence at incidence of the light flux 112 to the angle of divergence control unit 170. The display device 20 includes the field of view control unit illustratively based on the angle of divergence control unit 170.

The light flux generation unit 110 can be illustratively based on the projector 111 to generate the light flux 112 forming the projected image. The image formation unit 160 can be illustratively based on a screen 161 shaped like a dome, is provided in front of the image viewer 100 and reflects the light flux 112 to form an image 463. Moreover, the angle of divergence control unit 170 can be based on a lens 171 or the like, and enables the angle of divergence of the light flux 112 to be controlled, making the light flux 112 incident to the one-eye 105 of the image viewer 100. The screen 161 preferably has light diffusivity being decreased to some extent so that the light flux 112 having the angle of divergence controlled by the angle of divergence control unit 170 is incident to the one-eye, and can be based on an acryl resin or the like with substantially no diffusivity.

Like this, the display device 20 illustrated in FIG. 5 controls the angle of divergence and has the light flux 112 incident to the one eye of the image viewer 100, and thus can provide the projected image with higher brightness but lower power consumption than presenting the light flux with a broad area to the viewer 100 such as incidence to both eyes.

Furthermore, in the display device 20 illustrated in FIG. 5, a distance between the screen 161 and the one-eye 105 of the viewer 100 for viewing is set to 27 cm. This achieves the enhanced effect of perceiving the sense of depth as described above. That is, in the display device 20 illustrated in FIG. 5, among optical elements comprising the light flux generating unit 110, the image formation unit 160 and the angle of divergence control unit 170, the optical element 190 (nearest optical element) nearest to the one-eye 105 for viewing is the image formation unit 160 (screen 161), the distance between this and the one-eye 105 for viewing is 27 cm.

This enables display allowing perception with the enhanced sense of depth to be achieved easily without necessity of the complex device configuration and image processing, and display giving the high sense of realism to be achieved.

In the display device 20 described above, the angle of divergence of the light flux 112 is controlled to present the projected image to the one-eye 105 of the image viewer 100. An irradiation state of the light flux 112 to the image viewer 100 at this time will be described.

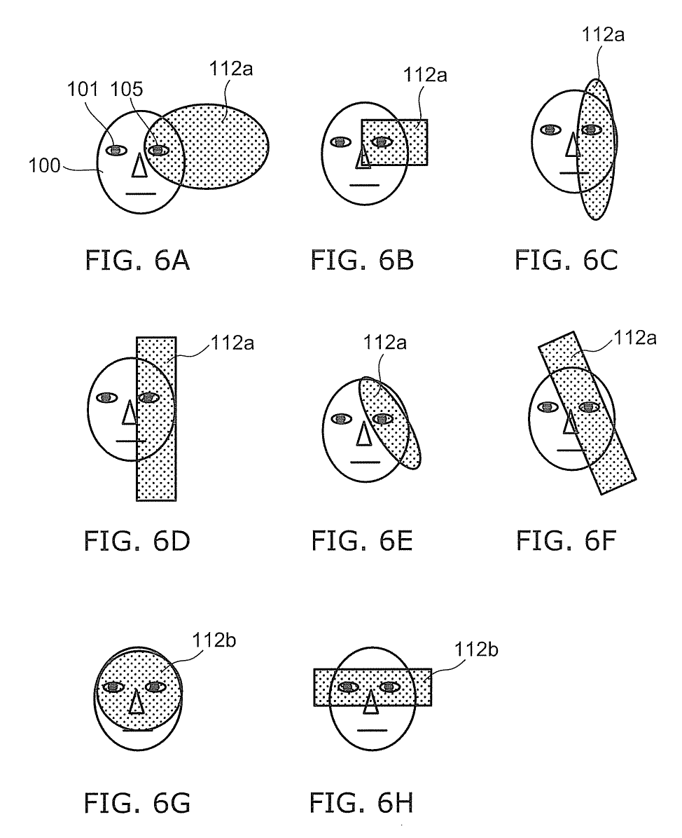

FIG. 6 shows schematic views illustrating the shape of light flux of the display device according to the second embodiment of the invention.

FIGS. 6A to 6F illustrate favorable states of the light flux 112 in the display device of this embodiment. And FIGS. 6G and 6H illustrate unfavorable state of the light flux 112.

As shown in FIGS. 6A to 6F, it is necessary that an irradiation area 112a of the light flux 112 to the image viewer 100 does not overlap with the one-eye 101 of the image viewer 100 not used for viewing and overlaps with the one-eye 105 for viewing, and its area may have any shape. More specifically, shapes may be laterally broad as illustrated in FIGS. 6A to 6D and vertically long as illustrated in FIGS. 6C and 6D, or else swash as illustrated in FIGS. 6E and 6F. On the contrary, no incidence of the light flux to both eyes should be avoided as illustrated in FIGS. 6G and 6H.

The control of the irradiation region 112a of the light flux 112 to the image viewer 100 can be achieved by controlling the angle of divergence of the light flux 112. That is, it can be achieved by the lens 171 or the like illustrated in FIG. 5. Furthermore, it can be achieved by various optical elements 190.

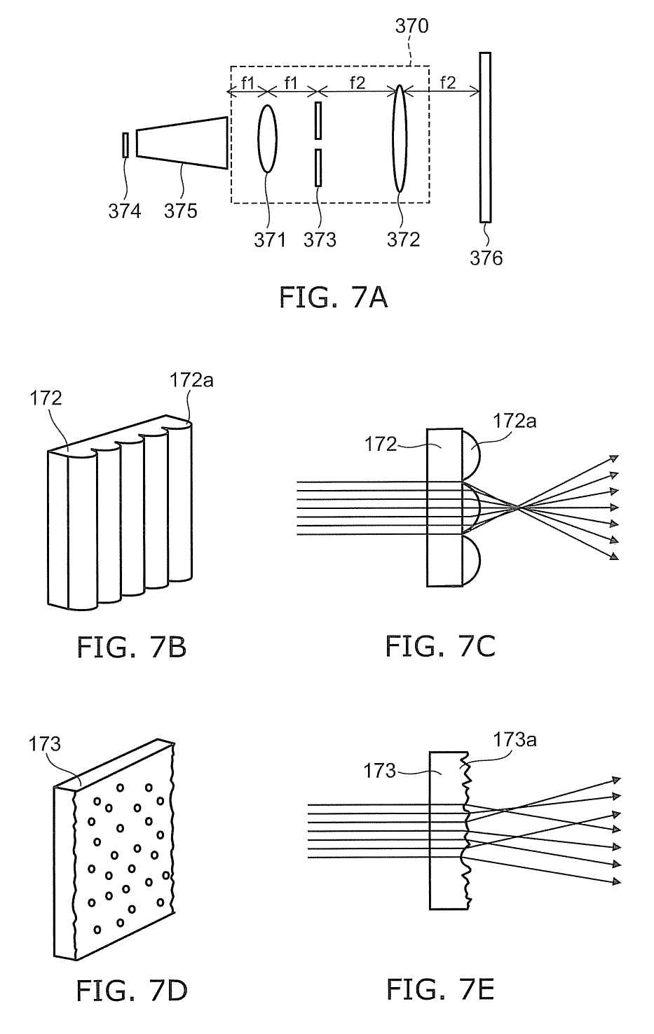

FIG. 7 shows schematic views illustrating the angle of divergence control unit of the display device according to the second embodiment of the invention.

As shown in FIG. 7A, the angle of divergence control unit 170 (370) can be based on, for example, optical elements of a first lens 371, an aperture 373 and a second lens 372. Moreover, if a focal length of the first lens is f1 and a focal length of the second lens is f2, the aperture 373 is placed at the position of the distance of f1 from the first lens 371 and f2 from the second lens 372. The angle of divergence control unit 370 in this configuration can be used by combining, for example, a light source 374, a collimator unit 375 and an image device 376 illustratively based on a liquid crystal display element forming the projected image. Moreover, the first lens 371 is placed so that the distance from the exit position of the collimator unit 375 to the first lens 371 is f1 and the second lens is placed so that the distance from the second lens 372 to the image device 376 is f2. Hereby the light flux from the light source 374 is collected by the aperture 373 and is incident to the image device 376 in a further controlled sate of the angle of divergence by the second lens 372. The light flux incident to the image device 376 arrives at the image viewer as the light flux having the controlled angle of divergence. At this time, the irradiation area 112a of the light flux 112 can be controlled easily by varying the diameter of the image device 376 and the light flux can be incident to the one eye of the image viewer 100.

Moreover, as shown in FIG. 7B, the angle of divergence control unit 170 can be based on, for example, a lenticular plate 172. As shown in FIG. 7C, the angle of divergence can be controlled by illustratively varying a curvature of a semi-cylindrical lens 172a of the lenticular plate 172. For example, as illustrated in FIGS. 6C to 6F, this lenticular plate can be used for achieving the angle of divergence collected into a longitudinal direction (one direction).

Moreover, as shown in FIG. 7D, the angle of divergence control unit 170 can be based on a holographic diffuser 173. As shown in FIG. 7E, the holographic diffuser 173 has micro irregularity 173a on its surface, and the angle of divergence can be controlled by varying a shape, size and a distribution density or the like of this micro irregularity 173a.

Furthermore, the angle of divergence control unit can be based on various optical elements.

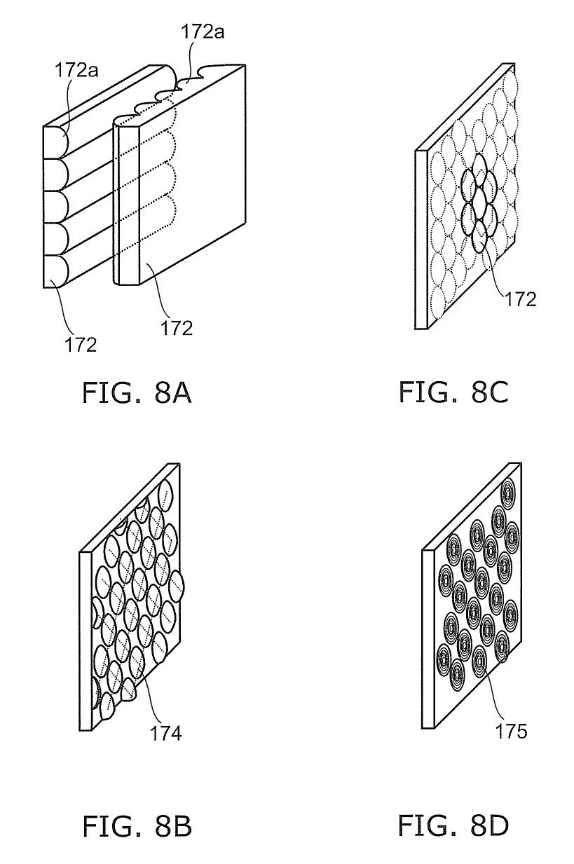

FIG. 8 shows schematic views illustrating the angle of divergence control unit of the display device according to the second embodiment of the invention.

As shown in FIG. 8A, the angle of divergence control unit 170 can be based on the optical element arranged so that extending directions of each semi-cylindrical lenses 172a are substantially perpendicular and semi-cylindrical lenses 172a are faced each other. Moreover, as shown in FIG. 8B, the optical element can be also used, which has a micro lens array having micro lenses 174 shaped like a dome arranged in a straight line on a flat plate.

Moreover, as shown in FIG. 8C, the optical element can be also used, which has a micro lens array having micro lenses 174 shaped like a dome arranged in a hexagonal closed packing on a flat plate.
Furthermore, as shown in FIG. 8D, the optical element may be also used, which has a micro lens array having two dimensionally distributed grated index type micro lenses 175 with substantially circular refractive index distribution on a flat plate.

In the angle of divergence control unit 170 composed of various optical elements 190 like this, the angle of divergence of the light flux 112 can be controlled by controlling shapes of the semi-cylindrical lenses 172a and the micro lenses 174 shaped like a dome and the refractive index of used materials, and the refractive index distribution of the grated index type micro lenses 175. In addition, other than the above, various optical elements, for example, a prism sheet having a plurality of crests and grooves shaped like a triangle pole arranged in parallel, various louver sheets, arrangement of a plurality of waveguides shaped like a top truncated triangular pyramid or the like can be used for the angle of divergence control unit 170.

On the other hand, in the display device 20 of this embodiment, optical elements with various configurations can be used for the image formation unit 160.

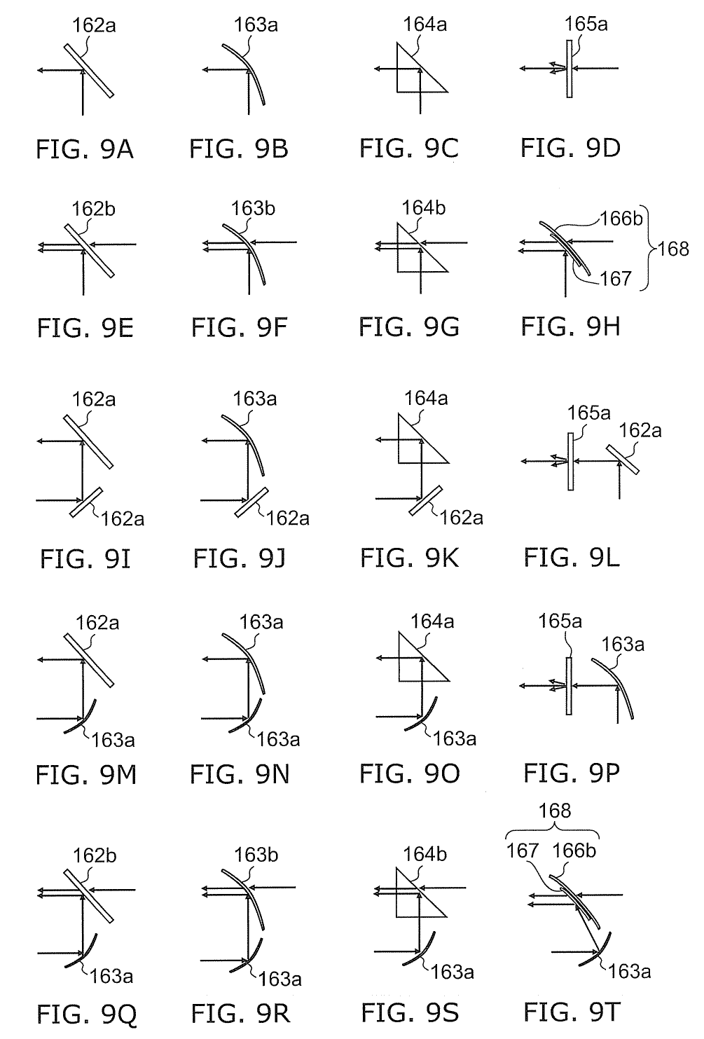

FIG. 9 shows schematic views illustrating the image formation unit of the display device according to the second embodiment of the invention.

As illustrated in FIGS. 9A to 9D, the image formation unit 160 can be based on optical elements such as a flat plate mirror 162a, a concave mirror 163a, a prism 164a and a diffusion screen 165a or the like.

Furthermore, as illustrated in FIGS. 9E to 9G, the image formation unit 160 can be based on optical elements such as a semi-transparent flat mirror 162b, a concave mirror 163b and a prism 164b or the like.

Moreover, as illustrated in FIG. 9H, optical elements of a laminated optical body 168 or the like made of a light transmission plate 166b with a slow curve and a highly reflective layer 167 provided thereon can be also used. Moreover, a structure provided with the highly reflective layer 167 on respective surfaces of the above flat plate mirror 162a, the concave mirror 163a, the prism 164a, the diffusion screen 165a, the semi-transparent flat mirror 162b, the concave mirror 163b and the prism 164b can be also used. The highly reflective layer 167 can be composed of films and laminated films made of various inorganic compounds and organic compounds.

As described above, use of optical elements with the semi-transparency illustratively allows simultaneous viewing of the image of the background and the projected image, and is easily applied to, for example, the HUD or the like.

Furthermore, the image formation unit 160 can be made up of combination of a plurality of above various optical elements.

More specifically, as illustrated in FIGS. 9I to L, a structure combining the flat plate mirror 162a, the concave mirror 163a, the prism 164a, the diffusion screen 165a and the flat plate mirror 162a can be used.

Moreover, as illustrated in FIGS. 9M to 9P, a structure combining the flat plate mirror 162a, the concave mirror 163a, the prism 164a, the diffusion screen 165a and the concave mirror 163a can be also used.

Moreover, as illustrated in FIGS. 9Q to 9T, a structure combining the semi-transparent flat mirror 162b, the concave mirror 163b, the prism 164b, the laminated optical body 168 of the light transmission plate 166b and the highly reflective layer 167, and the concave mirror 264a can be also used.

Furthermore, the optical elements can be based on various mechanisms deflecting a light path such as a polyhedral mirror, a pentagonal prism, a pentagonal mirror, a polygonal prism and a polygonal mirror. A concave shaped mirror or the like configured by arranging a plurality of micro flat plate mirrors may be used.

In addition, the image formation unit 160 may be based on combination of these optical elements with, for example, a light collection optical element such as an aspheric Fresnel lens or the like.

Moreover, the angle of divergence control unit 170 may be served as the image formation unit 160. The optical element comprising the angle of divergence control unit 170 may be served as a part of optical elements comprising the image formation unit 160. When the angle of divergence control unit 170 is composed of a plurality of optical elements A1 to An and the image formation unit 160 is composed of a plurality of optical components B1 to Bn, optical elements A1 to An and B1 to Bn can be arranged arbitrarily as long as its performance is exercised. For example, they can be also arranged in an order of A1, A2, A3 through An, B1, B2, B3 through Bn with respect to a traveling direction of the light flux 112, and also in an mixed order like as, for example, A1, B1, B2, A2, B3, A3 and further. That is, optical elements comprising the angle of divergence control unit 170 and the image formation unit 160 may be arranged in a mixed state each other.

On the other hand, in the display device 20 of this embodiment, the light flux generation unit 110 can be also based on various configurations. For example, a combined structure of a various types of light sources such as a laser, an LED (Light Emitting Diode) and a halogen lamp, with optical elements of mirrors or the like scanning the light flux generated by the light source can be used. Moreover, a combined structure of a various types of light sources with optical elements comprised of a various types of optical switches of LCD and MEMS or the like can be also used. Namely, an arbitrary configuration is possible as long as the light flux 112 containing the image information is generated.

It is noted that in the case where the light flux generation unit 110 includes optical elements, the angle of divergence control unit 170 may be served as optical elements comprising the image formation unit 160. Optical elements comprising the light flux generation unit 110 and optical elements comprising the angle of divergence control unit 170 and the image formation unit 160 may be arranged in a mixed state each other.

In the display device 20 of this embodiment, among optical elements comprising the light flux generation unit 110, the image formation unit 160 and the angle of divergence control unit 170, the distance between the optical element (nearest optical element) nearest to the one-eye 105 of the image viewer 100 for viewing and the one-eye 105 for viewing can be set to 21.7 cm or more. This can provide the enhanced effect of perceiving the sense of depth described in FIG. 4.

That is, as described in FIG. 4, the placement is made so that the distance between the nearest optical element and the one-eye 105 for viewing is preferably 21.7 cm, further preferably 25.5 cm or more and still further preferably 63.4 cm or more. This can provide the enhanced effect of perceiving the sense of depth.

Like this, the display device 20 of this embodiment enables display allowing perception with the enhanced sense of depth to be achieved easily without necessity of the complex device configuration and image processing, and display giving the high sense of realism can be achieved.

It is noted that for example, a pair of glasses for correcting one's eyesight or the like and sunglasses which the image viewer 100 wears are not regarded as optical elements comprising the light flux generation unit 110, the image formation unit 160, the angle of divergence control unit 170 and but regarded as a part of the image viewer 100.

### Third Embodiment

Next, a third embodiment will be described.

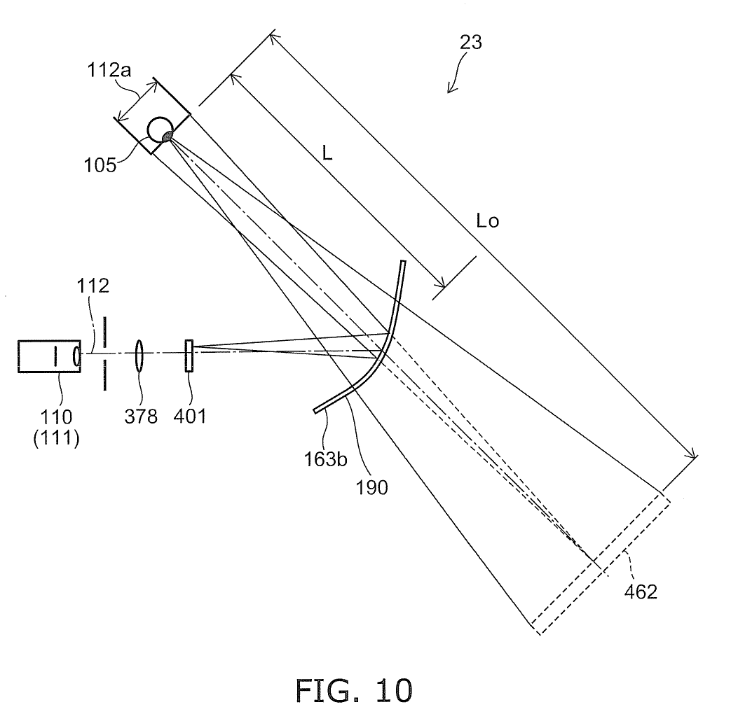

FIG. 10 is a schematic cross-sectional view illustrating the configuration of a display device according to the third embodiment of the invention.

As shown in FIG. 10, a display device 23 according to the third embodiment of the invention can be based on the projector 111 generating the light flux 112 containing image information as the light flux generation unit 110. The light flux 112 is projected on a lenticular plate 401 through a projection lens 378, the image is formed on the lenticular plate 401 and the real image is formed. This image is reflected by the semi-transparent spherical concave mirror 163b and the virtualized image is projected on the image viewer 100. The virtual image is given, being enlarged by the spherical concave mirror 163b. Moreover, the field of view of the projected image feasible for the image viewer 100 can be varied by the curvature of the concave mirror 163b. In addition, the lenticular plate 401 is illustrated, having the numerical aperture NA of 0.03 on an incidence side and the numerical aperture NA of 0.1 on the exit side, however, is not limited to these values.

In the display device in FIG. 10, the light flux generation unit 110 includes the projector 111, the projection lens 378 and the lenticular plate 401. Additionally, the image formation unit 160 and the angle of divergence control unit 170 are composed of the lenticular plate 401 and the concave mirror 163b. More specifically, the concave mirror 163b forms the virtual image 462 based on the light flux 112 of the real image formed on the lenticular plate 401. The angle of divergence of the lenticular plate 401 and the curvature of the concave mirror 163b enable the angle of divergence of the light flux 112 to be controlled, and the irradiation region 112a of the light flux 112 can be substantially a circle with a diameter of 6 cm at the position of the image viewer 100. This allows the light flux 112 to be incident to the one-eye of the image viewer 100 to present the projected image to the one-eye.

Moreover, in the display device 23, among the optical elements 190 comprising the light flux generating unit 110, the image formation unit 160 and the angle of divergence control unit 170, the optical element 190 (nearest optical element) nearest to the one-eye 105 of the image viewer 100 for viewing is the concave mirror 163b, the distance L between the concave mirror 163b and the one-eye 105 for viewing is set to 100 cm.

In the display device 23 configured like this, since the light flux 112 is incident to the one-eye 105 of the image viewer 100 and the distance between the nearest optical element and the one-eye for viewing is 21.7 cm or more, the enhanced effect of perceiving the sense of depth can be achieved. For example, while the distance Lo between the formation position of the virtual image 462 and the one-eye 105 is 300 cm in the display device 23 illustrated in FIG. 10, the image is perceived as if it is placed in a direction further than it, for example, perceived at a distance of 350 to 600 cm.

Like this, the display device 23 of this embodiment enables display allowing perception with the enhanced sense of depth to be achieved easily and display giving the high sense of realism can be achieved.

### Fourth Embodiment

Next, a fourth embodiment will be described.

FIG. 11 is a schematic view illustrating the configuration of a display device according to the fourth embodiment of the invention.

As shown in FIG. 11, in a display device 24 of the fourth embodiment, the flat plate mirror 162a and the laminated optical body 168 are used instead of the concave mirror 163b of the display device 23 illustrated in FIG. 10, and additionally an aspheric Fresnel lens 402 serving as a light collecting optical element is placed therebetween. The laminated optical body 168 is composed of the light transmission plate 166b and the semi-transparent highly reflective layer 167.

In the display device 24 illustrated in FIG. 11, the optical characteristics of the lenticular plate 401 enable the angle of divergence of the light flux 112 to be controlled, and the irradiation region 112a of the light flux 112 can be substantially a circle with a diameter of 6 cm at the position of the image viewer 100. This allows the light flux 112 to be incident to the one-eye of the image viewer 100 to present the projected image to the one-eye.

Moreover, the nearest optical element is the laminated optical body 168. The distance between this laminated optical body 168 and the one-eye 105 for viewing is set to 100 cm. Hereby, the display device 24 enables display allowing perception with the enhanced sense of depth to be achieved easily and display giving the high sense of realism can be achieved.

In addition, the display device 24 illustrated in FIG. 11 has an advantage of achieving downsizing of the device configuration compared with the display device 23 illustrated in FIG. 10, because the flat plate mirror 162a is placed under an field of view for viewing 403 of the image viewer 100. Moreover, the adjustment of the angle of the flat plate mirror 162a can control a direction of the outgoing light flux 112, and the adjustment of the outgoing direction of the light flux 112 depending on variation of the position of the image viewer 100 can present the projected image to the one-eye 105 of the image viewer 100.

In addition, the light collecting optical element can be also based on a normal spherical lens and a concave mirror or the like other than the above aspheric Fresnel lens 402. The flat plate mirror 162a can be alternated by the concave mirror 163a.

The display device 24 illustrated in FIG. 11 can be used for the HUD by setting the light transmission plate 166b to front glass of a vehicle or the like.

More specifically, in the HUD, the projected image such as vehicle information is presented on the front glass as a virtual image. Here, in a normal HUD, the formation position of the virtual image is located approximately at 1.5 to 2.5 m (approximately the same position as the front edge of the vehicle) from the image viewer, however, in a normal driving state, a driver watches a vehicle in front of the driving vehicle and road conditions, and often visually identifies farther than the front edge of the driving vehicle, being different from the formation position of the virtual image. Thus, in a conventional HUD, visibility of the projected image is inferior. On the contrary, if the display device 24 of this embodiment is applied to an HUD, the virtual image can be perceived at farther than the formation position of the virtual image, thus the HUD with superior visibility can be achieved to support a safer driving of vehicles or the like.

In addition, providing a control unit 601 controlling placement positions and angles of, for example, the projector 111, the projection lens 378 and the lenticular plate 401 or the like other than the placement position and the angle of the flat plate mirror 162a can present good projected images to the image viewer 100.

### Fifth Embodiment

Next, a fifth embodiment will be described.

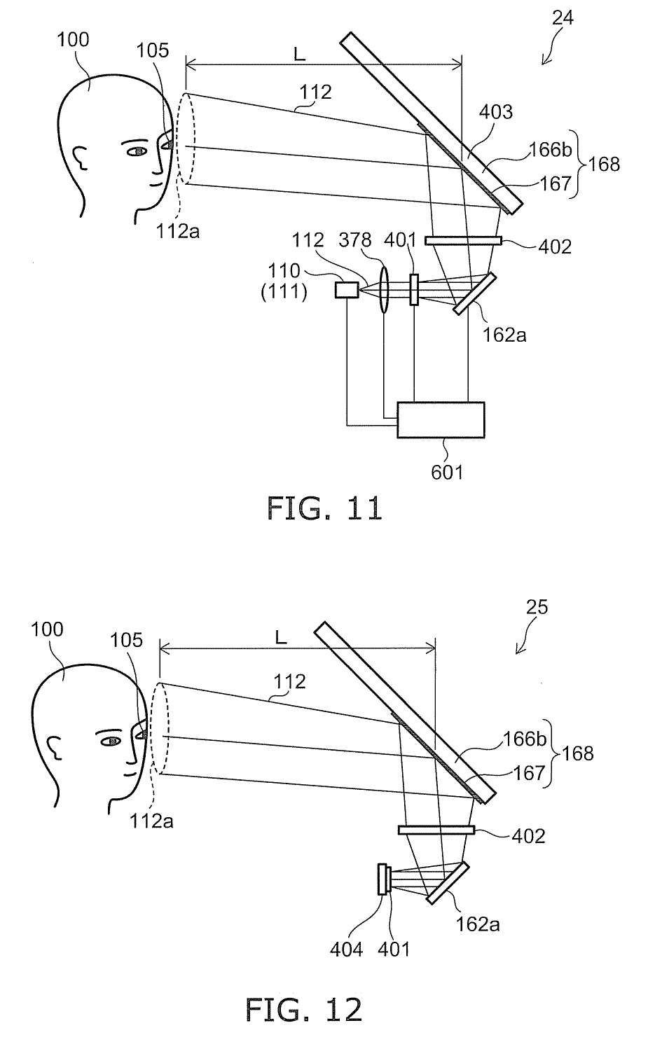

FIG. 12 is a schematic view illustrating the configuration of a display device according to the fifth embodiment of the invention.
As shown in FIG. 12, in a display device 25 of the fifth embodiment an LCD 404 having a backlight is used as the light flux generation unit 110 of the display device 24 illustrated in FIG. 11. Moreover, in front of the LCD, the lenticular plate 401 is placed as the angle of divergence control unit 170.

In the display device 25 illustrated in FIG. 12, the optical characteristics of the lenticular plate 401 enable the angle of divergence of the light flux 112 to be controlled, and the irradiation region 112a of the light flux 112 can be substantially a circle with a diameter of 6 cm at the position of the image viewer 100. This allows the light flux 112 to be incident to the one-eye of the image viewer 100 to present the projected image to the one-eye.

Moreover, the nearest optical element is the laminated optical body 168. The distance between this laminated optical body 168 and the one-eye 105 for viewing is set to 100 cm. Hereby, the display device 25 enables display allowing perception with the enhanced sense of depth to be achieved easily and display giving the high sense of realism can be achieved.

In addition, the display device 25 illustrated in FIG. 12 has an advantage of achieving downsizing of the device configuration compared with the display device 23 illustrated in FIG. 10, because the LCD 404 is used as the light flux generation unit 110. Moreover, the LCD 404 can be replaced to use various types display such as a CRT (Cathode Ray Tube), a fluorescent display tube (VFD: Vacuum Fluorescent Display), a PDP (Plasma Display Panel), an EL (Electro Luminescence) display device, an organic EL display device or the like.

### Sixth Embodiment

Next, a sixth embodiment will be described.

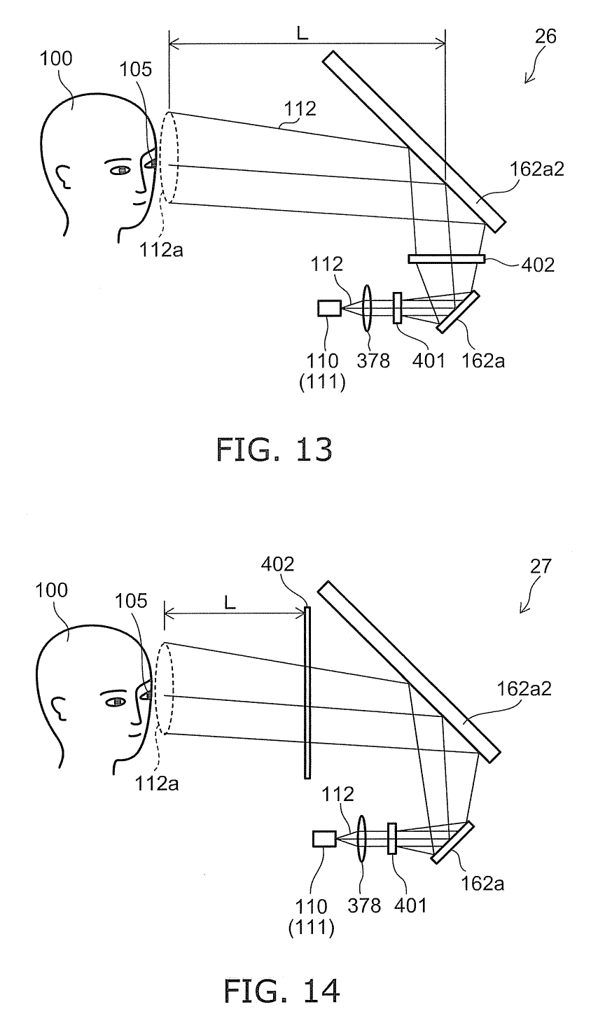

FIG. 13 is a schematic view illustrating the configuration of a display device according to the sixth embodiment of the invention.

As shown in FIG. 13, in a display device 26 of the sixth embodiment, a second flat plate mirror 162a2 is used instead of the laminated optical body 168 in the display device 24 illustrated in FIG. 11.

As with the display device 24, the display device 26 enables display allowing perception with the enhanced sense of depth to be achieved easily and display giving the high sense of realism can be achieved.

Moreover, for the display device 24 illustrated in FIG. 11, both the generated projected image and background information of the field of view for viewing 403 can be viewed, however, in the display device 26 illustrated in FIG. 13, the generated projected image is viewed, thus it is possible to perceive the projected image having the higher sense of realism, and displays for viewing and a game, and further suitable for various purposes generating prescribed environmental situations can be provided.

### Seventh Embodiment

Next, a seventh embodiment will be described.

FIG. 14 is a schematic view illustrating the configuration of a display device according to the seventh embodiment of the invention. As shown in FIG. 14, in a display device 27 of the seventh embodiment, the placement position of the aspheric Fresnel lens 402 of the display device 26 illustrated in FIG. 13 is changed from between the flat plate mirror 162a and the second flat plate mirror 162a2 to between the second flat plate mirror 162a2 and the image viewer 100. In this case, the nearest optical element is the aspheric Fresnel lens 402 and the distance between the aspheric Fresnel lens 402 and the one-eye of the image viewer for viewing is taken as 70 cm.

The display device illustrated in FIG. 14 presents the projected image to the one-eye of the image viewer 100 and has the distance L of 21.7 cm or more between the nearest optical element and the one-eye 105 for viewing, thus enables display allowing perception with the enhanced sense of depth to be achieved easily and display giving the high sense of realism can be achieved.

### Eighth Embodiment

Next, an eighth embodiment will be described.

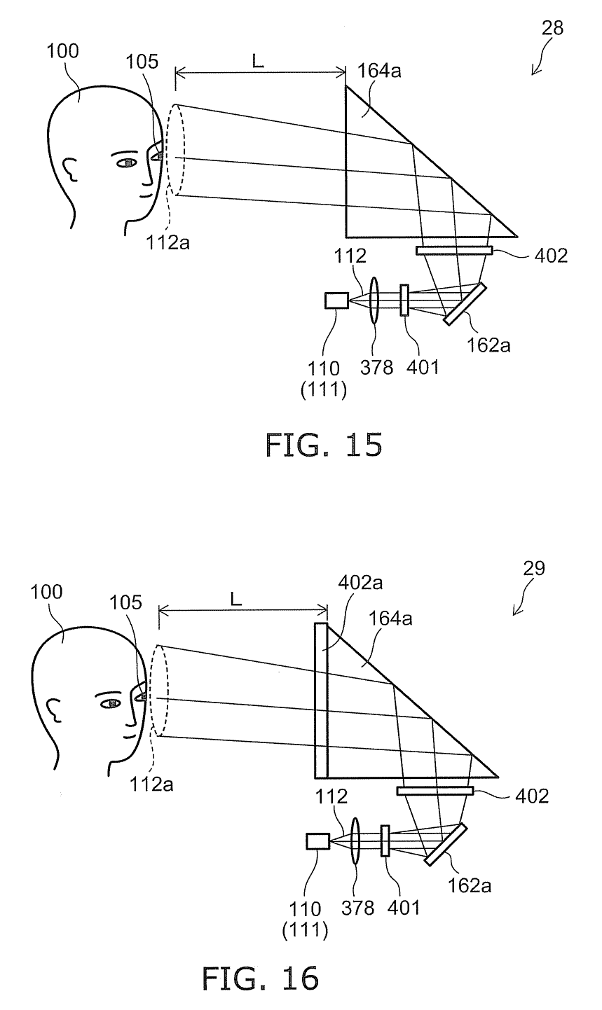

FIG. 15 is a schematic view illustrating the configuration of a display device according to the eighth embodiment of the invention.

As shown in FIG. 15, in a display device 28 of the eighth embodiment, the prism 164a is used instead of the second flat plate mirror 162a2 of the display device 26 illustrated in FIG. 13. The nearest optical element is this prism 164a, and the distance between the prism 164a and the one-eye 105 of the image viewer 100 for viewing is taken as 90 cm.

As with the display device 26, the display device 28 presents the projected image to the one-eye of the image viewer 100 and has the distance L of 21.7 cm or more between the nearest optical element and the one-eye 105 for viewing, thus enables display allowing perception with the enhanced sense of depth to be achieved easily and display giving the high sense of realism can be achieved.

### Ninth Embodiment

Next, a ninth embodiment will be described.

FIG. 16 is a schematic view illustrating the configuration of a display device according to the ninth embodiment of the invention.

As shown in FIG. 16, a display device 29 of the ninth embodiment has a structure further provided with an aspheric Fresnel lens 402a for correcting the light flux on the plane of the prism 164a at the image viewer 100 side. This allows the outgoing light from the prism 164a to be shaped to improve display uniformity. In addition, the nearest optical element in the display device is this aspheric Fresnel lens 402a and the distance between the aspheric Fresnel lens 402a and the one-eye 105 of the image viewer 100 for viewing is taken as 89 cm.

As with the display device 26, the display device 29 presents the projected image to the one-eye of the image viewer 100 and has the distance L of 21.7 cm or more between the nearest optical element and the one-eye 105 for viewing, thus enables display allowing perception with the enhanced sense of depth to be achieved easily and display giving the high sense of realism can be achieved.

### Tenth Embodiment

Next, a tenth embodiment will be described.

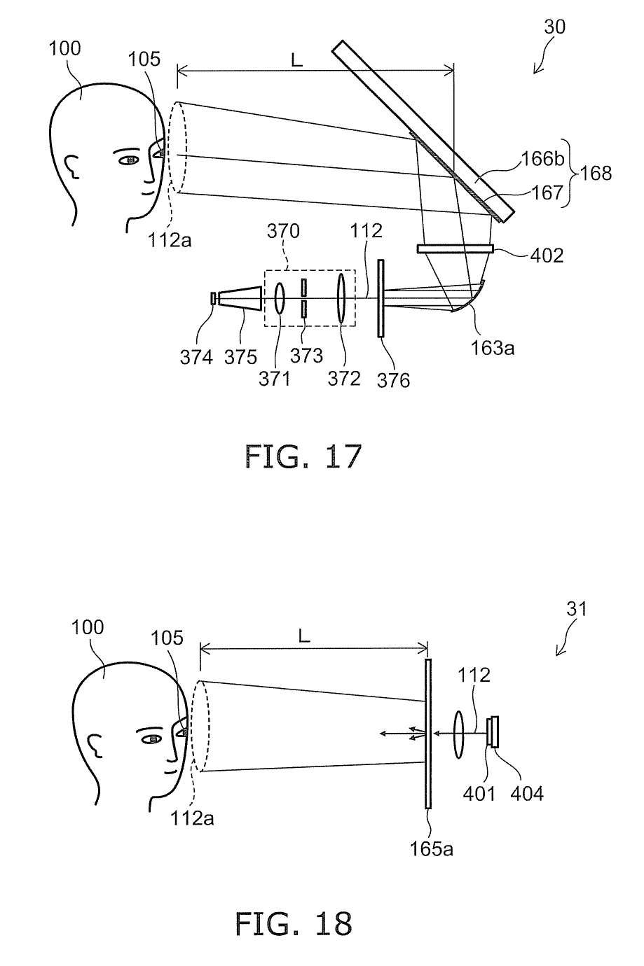

FIG. 17 is a schematic view illustrating the configuration of a display device according to the tenth embodiment of the invention.

As shown in FIG. 17, in a display device 30 of the tenth embodiment, the angle of divergence control unit 370 described in FIG. 7A is used as the angle of divergence control unit 170 of the display device 24 illustrated in FIG. 11. Moreover, it is combined with the light source 374 and the collimator unit 375, and the image device (LCD) 376 forming the projected image. Additionally, the flat plate mirror 162a in the display device 24 illustrated in FIG. 11 is replaced by the concave mirror 163a.

As with the display device 23, the display device 30 illustrated in FIG. 17 presents the projected image to the one-eye of the image viewer 100 and has the distance L of 21.7 cm or more between the nearest optical element and the one-eye 105 for viewing, thus enables display allowing perception with the enhanced sense of depth to be achieved easily and display giving the high sense of realism can be achieved.

### Eleventh Embodiment

Next, an eleventh embodiment will be described.

FIG. 18 is a schematic view illustrating the configuration of a display device according to the eleventh embodiment of the invention.

As shown in FIG. 18, in a display device 31 of the eleventh embodiment, as with the display device 25 illustrated in FIG. 12, the LCD 404 having the backlight and the lenticular plate 401 placed therefront are used, and the diffusion screen 165a is used for the image formation unit 160. The diffusivity (angle of divergence) of the diffusion screen 165a is controlled, and the image is caused to be presented to the one-eye 105 of the image viewer 100. Moreover, the distance L between the diffusion screen 165a serving as the nearest optical element and the one-eye 105 of the image viewer for viewing is set to 60 cm

The display device 31 illustrated in FIG. 18 presents the projected image to the one-eye of the image viewer 100 and has the distance L of 21.7 cm or more between the nearest optical element and the one-eye 105 for viewing, thus enables display allowing perception with the enhanced sense of depth to be achieved easily and display giving the high sense of realism can be achieved.

As described above, the light flux generation unit 110, the image formation unit 160 and the angle of divergence control unit 170 can be based on various optical parts and optical elements, respectively. In the display device according to the embodiment of the invention, constituent elements of the light flux generation unit 110, the image formation unit 160 and the angle of divergence control unit 170 can be used with a dual-purpose and be exchanged within a technically available range and optical parts and optical elements can be partly deleted.

Moreover, in the display devices of various embodiments, as with the display device illustrated in FIG. 11, the control unit 601 can be provided, controlling positions and angles and optical characteristics of various optical elements comprising the light flux generation unit 110, the image formation unit 160 and the angle of divergence control unit 170. This allows the irradiation region 112a of the light flux 112 to be effectively set corresponding to the one-eye 105 of the image viewer 100 and the image with a correct focus is effectively presented.

### Twelfth Embodiment

Next, a twelfth embodiment will be described. A display device of a twelfth embodiment controls an irradiation position of light flux by following the position of the image viewer (head).

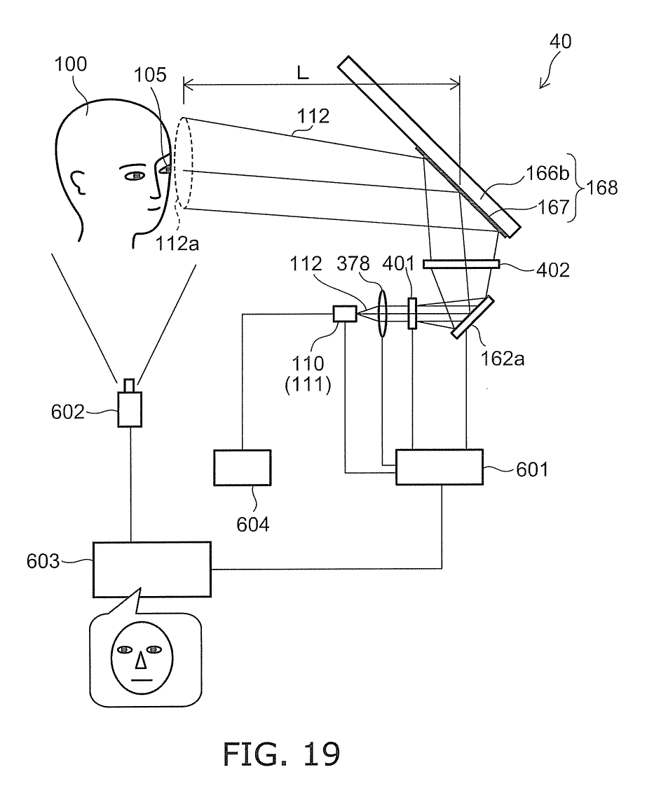

FIG. 19 is a schematic view illustrating the configuration of the display device according to the twelfth embodiment of the invention.

As shown in FIG. 19, a display device 40 of the twelfth embodiment further includes an image pickup unit 602 imaging the image viewer 100 (head) and an image judgment unit 603 processing the image imaged by the image pickup unit 602 and deriving the position of the eye of the image viewer 100 in addition to the display device 24 illustrated in FIG. 11. Then, the flat plate mirror 162a is set to be movable and configured so that the angle and position of the flat plate mirror 162a can be controlled by the control unit 601. Additionally, an image signal from an image signal unit 604 is input to the projector 111.

The image judgment unit 603 can identify positions of both eyeballs, a nose and a mouth or the like serving as characterizing points of the face of the image viewer 100 on the basis of imaging data, for example, using the method described in the Patent Document 2. This allows the position of eyes of the image viewer 100 to be identified and derived.

On the basis of the data on the position of eyes of the image viewer 100 derived by the image judgment unit 603, the control unit 601 varies, for example, the position and angle of the movable flat plate mirror 162a, then the projected image can be presented to the one-eye 105 of the image viewer 100 for viewing. Hereby, the movement of the head of the image viewer 100 is automatically followed and it becomes possible to control the presentation position of the projected image. Misalignment of the presentation position by the movement of the head of the image viewer 100 becomes not to occur and it becomes possible to take a practical view range broadly. This enables perception with the enhanced sense of depth to be provided stably, and display giving the stable sense of realism to be achieved.

By the way, imaging the head of the image viewer 100 may be either performed by direct imaging or by imaging the light outgoing from any of optical elements comprising the display device. Moreover, in the display device 40 illustrated in FIG. 19, the presentation position of the projected image to the image viewer 100 is controlled by the movable flat plate mirror 162a, however, not limited to this, all technically available optical elements among various optical elements comprising the display device can be targets to be adjusted.

Moreover, the display device 40 of this embodiment varying the position of the light flux 112 by automatically following the position of the eye of the image viewer 100 like this can be applied to, for example, to the HUD, and can stably provide display allowing the perception with the enhanced sense of depth to support the safer driving of vehicles or the like.

### Thirteenth Embodiment

Next, a display method of a thirteenth embodiment will be described.

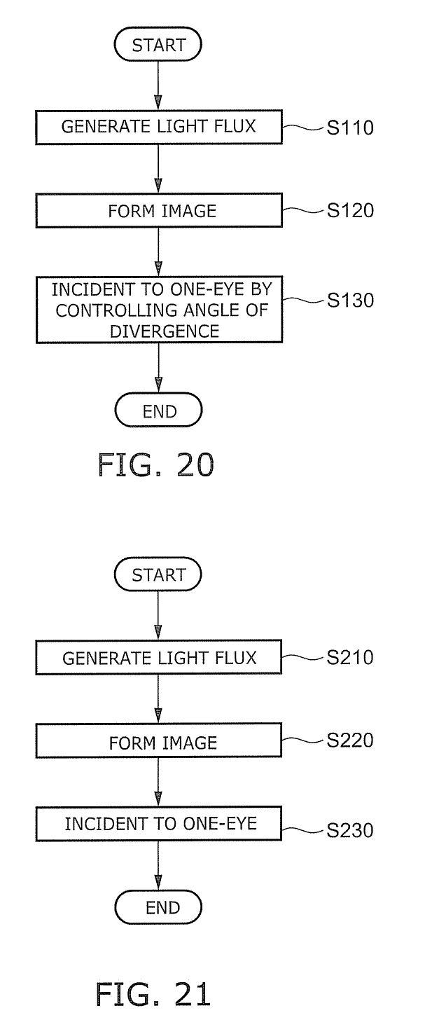

FIG. 20 is a flow chart illustrating the display method according to the thirteenth embodiment of the invention.

As shown in FIG. 20, in the display method of the thirteenth embodiment, in the first place, light flux 112 containing projected image information is generated (step S110). Generation of the light flux can be based on a structure combining various light sources such as the laser, LED and the halogen lump previously described and an optical element 190 such as a mirror or the like scanning the light flux generated by the light source. Moreover, a structure or the like combining various light sources with the optical element 190 composed of various optical switches of LCD and MEMS or the like can be used.

Next, an image is formed on the basis of the light flux 112 (step S120). The image can be formed using a semi-transparent or reflective flat plate mirror, a concave mirror, a prism, a diffusion screen and a laminated optical body of a light transmission plate and a highly reflective layer or the like.

Next, the light flux 112 is caused to be incident to a one-eye of an image viewer 100 by controlling an angle of divergence of the light flux 112 (step S130). The angle of divergence of the light flux 112 can be controlled using the previously described combination of the lens and the aperture, the lenticular plate, the holographic diffuser, the micro lens array, the grated index type micro lens, various prism sheets, the louver sheet and the arrangement of a plurality of wave guides shaped like a top truncated pyramid or the like.

This allows display with high brightness and low electric power consumption to be achieved and setting a distance between a nearest optical element and the one-eye of the image viewer 100 for viewing to 21.7 cm or more enables display allowing perception with an enhanced sense of depth to be achieved easily and display giving a high sense of realism to be achieved, furthermore display supporting a safe driving of vehicles or the like to be achieved.

### Fourteenth Embodiment

Next, a display method of a fourteenth embodiment will be described.

FIG. 21 is a flow chart illustrating the display method according to the fourteenth embodiment of the invention.

As shown in FIG. 21, in the display method of the fourteenth embodiment, in the first place, the light flux 112 containing the projected image information is generated (step S210).

Next, the image is formed on the basis of the light flux 112 (step S220). The image can be formed using the semi-transparent or reflective flat plate mirror, the concave mirror, the prism, the diffusion screen and the laminated optical body of the light transmission plate and the highly reflective layer or the like.

Next, the optical element nearest to the one-eye of the image viewer 100 for viewing (nearest optical element) is placed apart from the one-eye for viewing by 21.7 cm or more, and the light flux is incident to the one-eye of the image viewer 100 (step S230). This enables display allowing perception with the enhanced sense of depth to be achieved easily and display giving the high sense of realism to be achieved.

### Fifteenth Embodiment

Next, a display method of a fifteenth embodiment will be described.

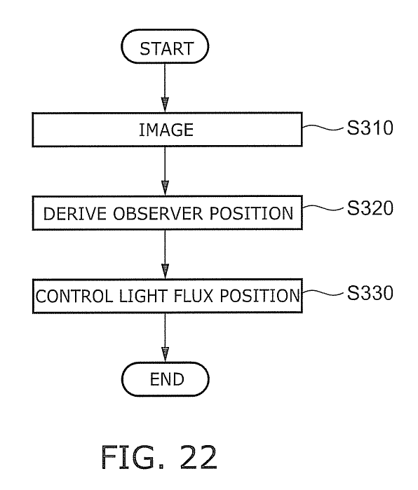

FIG. 22 is a flow chart illustrating the display method according to the fifteenth embodiment of the invention.

The display method of the fifteenth embodiment includes the following in addition to the display method of the thirteenth embodiment and the fourteenth embodiment.

More specifically, as shown in FIG. 22, in the first place, the image viewer is imaged (step S310). Imaging can be based on a CCD camera and a CMOS sensor or the like.

Next, the imaged image is processed to derive the position of the one-eye of the image viewer (step S320). In this case, the method of image processing and recognition illustratively includes a method identifying the position of the one-eye of the image viewer 100 by identifying positions of both eyeballs, a nose and a mouth or the like serving as characterizing points of the face of the image viewer 100, for example, as described in the Patent Document 2 (step S320). Next, the irradiation position of the light flux on the image viewer is controlled on the basis of the information on the derived position of the one-eye (step S330).

Hereby, the movement of the head of the image viewer 100 is automatically followed and it becomes possible to control the presentation position of the projected image. This enables the projected image allowing stable perception with the sense of depth to be achieved easily and display giving the high sense of realism to be achieved. Moreover, application to HUD or the like can support effectively the safer driving of vehicles or the like.

### Sixteenth Embodiment

A head-up display (HUD) of a sixteenth embodiment of the invention is a head-up display for a car for which the display device and display method described above are used.

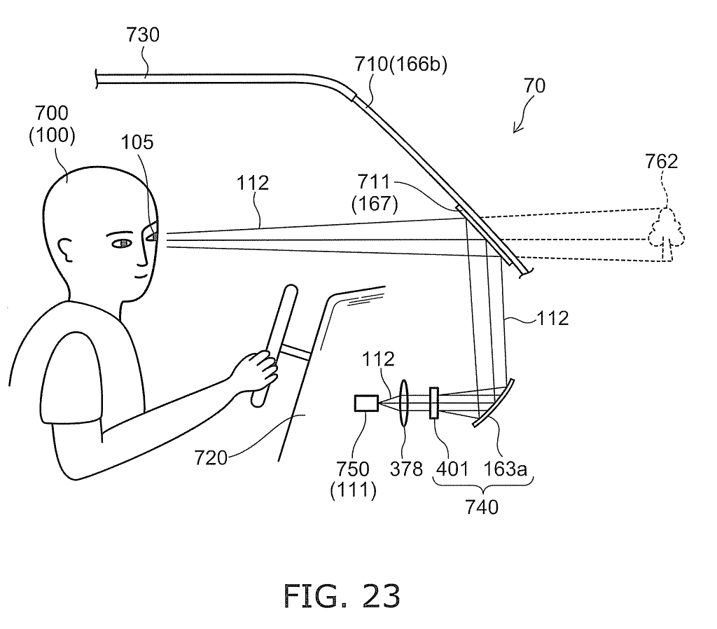

FIG. 23 is a schematic view illustrating the configuration of the head-up display according to the sixteenth embodiment of the invention.

As shown in FIG. 23, a head-up display (HUD) 70 of the sixteenth embodiment of the invention is provided with the above described projector 111, the projection lens 378, the lenticular plate 401 and the concave mirror 163a on the back of a dashboard 720 of a car (vehicle) 730 viewed from a driver 700 (image viewer 100). The projector 111 generates the light flux 112. The outgoing light flux 112 having the angle of divergence controlled by the projection lens 378, the lenticular plate 401 and the concave mirror 163a is set configured to be incident to the one-eye 105 of the driver 700 (image viewer 100). That is, this is the example which a light flux projection unit 750 is based on the projector 111 and an angle of divergence control mechanism 740 is based on the lenticular plate 401 and the concave mirror 163a.

Moreover, a reflective layer (half mirror) 711 reflecting the light flux 112 is provided on a part of a front glass (window shield, transparent plate) 710 of the car 730. That is, the front glass 710 and the reflective layer 711 carry out respective functions of the light transmission plate 166b and the highly reflective layer 167 illustrated in FIG. 9H. The reflective layer 711 functions as a combiner of HUD. The light flux 112 having the angle of divergence controlled by the angle of divergence control mechanism 740 is projected on the reflective layer 711 and the projected image is presented to the one-eye 105 of the driver 700 (image viewer 100). The driver 700 (image viewer 100) views a virtual image 762 with one-eye. This enables the HUD of the embodiment to provide display allowing perception with the enhanced sense of depth to the driver 700 to support the safer driving of vehicles or the like.

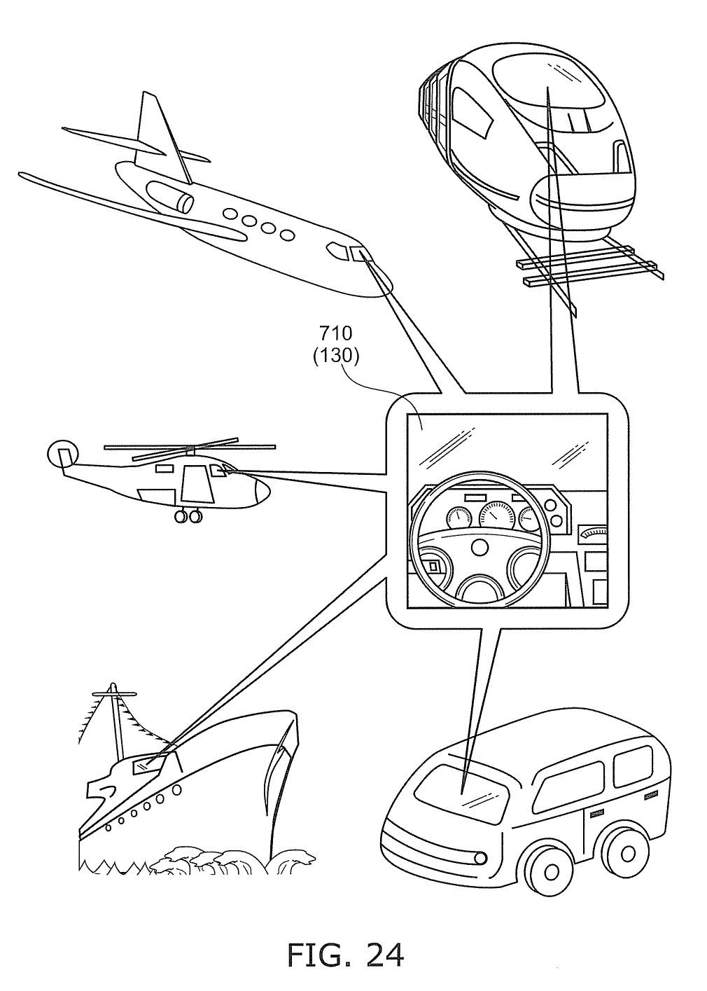

FIG. 24 is a schematic view for describing application examples of the display device, the display method and the head-up display according to the embodiments of the invention.

The described above display device, the display method and the head-up display can be applied to various movable bodies such as a train, an aircraft, a helicopter and a ship or the like other than the vehicle of car or the like.

The embodiments of the invention have been described with reference to the examples. However, the invention is not limited to the above examples. For instance, the specific configuration of respective elements comprising the display device, the display method and the head-up display are encompassed within the scope of the invention as long as a person skilled in the art may also work the invention by selecting as appropriate from the publicly known scope and take the similar effect.

Moreover, two or more of the elements in each example can be combined as long as technically feasible, and such combinations are also encompassed within the scope of the invention as long as they include the features of the invention.

In addition, all display devices, display methods and head-up displays which a person skilled in the art may invent within the range of design variation on the basis of the display device, the display method and the head-up display described above as the embodiments of the invention also belong to the scope of the invention as long as they include the features of the invention.

In addition, a person skilled in the art could have made various conversions and modifications within the category of the idea of the invention, and such conversions and modifications are considered to belong to the scope of the invention.

### INDUSTRIAL APPLICABILITY

The invention provides a display device, a display method and a head-up display which allows the perceivable projected image of the enhanced sense of depth to be achieved easily and a high sense of realism to be displayed without necessity of a complex device configuration and image processing and supports the safer driving of vehicles or the like.

1. A display device, generating light flux containing image information and making the light flux incident to one-eye of an image viewer by controlling an angle of divergence of the light flux,
the device comprising a first lens, a second lens and an angle of divergence control device provided between the first lens and the second lens, the angle of divergence control device being configured to control the angle of divergence of the light flux.

2. The device according to claim 1, wherein a distance between an optical element nearest to the one-eye of optical elements included in the display device and the one-eye is 21.7 cm or more.

3. The device according to claim 1, wherein a distance between an optical element nearest to the one-eye of optical elements included in the display device and the one-eye is 25.5 cm or more.

4. The device according to claim 1, wherein a distance between an optical element nearest to the one-eye of optical elements included the display device and the one-eye is 63.4 cm or more.

5. A display device comprising:
a light flux generation unit configured to generate light flux containing image information;
a field of view control unit configured to make the light flux incident to one-eye of an image viewer; and
an image formation unit configured to form an image based on the light flux, the image formation unit including an optical element nearest to the one-eye of constituent optical elements, which is placed apart from the one-eye by 21.7 cm or more,
at least one of the field of view control unit and the image formation unit including a first lens, a second lens and an angle of divergence control device provided between the first lens and the second lens, the angle of divergence control device being configured to control the angle of divergence of the light flux.

6. The device according to claim 5, wherein the optical element nearest to the one-eye of constituent optical elements of the image formation unit is placed apart from the one-eye by 25.5 cm or more.

7. The device according to claim 5, wherein the optical element nearest to the one-eye of constituent optical elements of the image formation unit is placed apart from the one-eye by 63.4 cm or more.

8. The device according to claim 5, wherein the field of view control unit and the image formation unit include at least one selected from a group consisting of an optical structure body including a lens and an aperture, a lenticular plate, a holographic diffuser, a microlens array, a grated index type microlens, a prism sheet, a louver sheet and an optical structure body having a plurality of waveguide shaped like a top truncated triangular pyramid arrayed.

9. The device according to claim 5, wherein the light flux generation unit includes a light source and any one of an optical element scanning the light flux generated in the light source and a light switch modulating the light flux.

10. The device according to claim 5, further comprising:
an image pickup unit configured to image the image viewer;
an image judgment unit configured to process the image imaged by the image pickup unit and to derive a position of the one-eye of the image viewer; and
a control unit configured to control direction of the light flux based on information about the derived position of the one-eye by the image judgment unit.

11. The device according to claim 10, wherein the control unit controls at least any of a position and an angle of optical elements included in the light flux generation unit, the field of view control unit and the image formation unit.

12. A display method, generating light flux containing image information and making the light flux incident to one-eye of an image viewer by controlling an angle of divergence of the light flux by using a first lens, a second lens and an angle of divergence control device provided between the first lens and the second lens, the angle of divergence control device being configured to control the angle of divergence of the light flux.

13. The method according to claim 12, wherein
the image viewer is imaged,
the imaged image is processed and a position of the one-eye of the image viewer is derived, and
the direction of the light flux is further controlled based on information about the derived position of the one-eye.

14. A display method,
generating light flux containing image information, and
making the light flux incident to the one-eye by placing an optical element nearest to one-eye of an image viewer apart from the one-eye by 21.7 cm or more by using a first lens, a second lens and an angle of divergence control device provided between the first lens and the second lens, the angle of divergence control device being configured to control the angle of divergence of the light flux.

15. The method according to claim 14, wherein the light flux is made incident to the one-eye by placing the optical element nearest to the one-eye of the image viewer apart from the one-eye by 25.5 cm or more.

16. The method according to claim 14, wherein the light flux is made incident to the one-eye by placing the optical element nearest to the one-eye of the image viewer apart from the one-eye by 63.4 cm or more.

17. The method according to claim 14, wherein the display method making the light flux incident to the one-eye includes a method controlling an angle of divergence of the light flux using an optical system including at least one selected from a group consisting of an optical structure body including a lens and an aperture, a lenticular plate, a holographic diffuser, a microlens array, a grated index type microlens, a prism sheet, a louver sheet and an optical structure body having a plurality of waveguide shaped like a top truncated triangular pyramid arrayed.

18. The method according to claim 14, wherein
the image viewer is imaged,
the imaged image is processed and a position of the one-eye of the image viewer is derived, and
the direction of the light flux is further controlled based on the derived position information of the one-eye.

19. A head-up display comprising:
a light flux projection unit configured to output light flux containing image information configured to be incident to one-eye of an driver;
an angle of divergence control mechanism configured to control an angle of divergence of the light flux, the angle of divergence control mechanism including a first lens, a second lens and an angle of divergence control device provided between the first lens and the second lens, the angle of divergence control device being configured to control the angle of divergence of the light flux; and
a transparent plate provided with a reflecting layer having the light flux projected thereon with the angle of divergence controlled by the angle of divergence control mechanism.
